(19) United States
(12) Patent Application Publication
(10) Pub. No.: US 2019/0332060 A1
(43) Pub. Date: Oct. 31, 2019

(54) ELECTRONIC TIMEPIECE

(71) Applicant: Seiko Epson Corporation, Tokyo (JP)

(72) Inventor: Yoshihide KANEKO, Shiojiri (JP)

(21) Appl. No.: 16/394,127

(22) Filed: Apr. 25, 2019

(30) Foreign Application Priority Data
Apr. 26, 2018 (JP) 2018-085214

(51) Int. Cl. G04B 19/23; G04C 3/14

(52) U.S. Cl. CPC G04B 19/235; G04C 3/14

(57) ABSTRACT

An electronic timepiece improves operability when the user adjusts the hand positions. The electronic timepiece has an operator, hands, a driver for driving the hands, and a controller that controls the driver in a first mode or a second mode. In the first mode, the controller drives the hands rapidly at a first speed, and continues rapidly driving the hands until a specific operation is executed by the operator. In the second mode, the controller drives the hands rapidly at a second speed that is faster than the first speed, and stops the hands when the hands have moved to a specific position.

### BACKGROUND

### 1. Technical Field

The present invention relates to an electronic timepiece.

### 2. Related Art

Electronic timepieces that rapidly drive the hands to adjust the hand positions are known from the literature. See, for example, JP-A-2012-202901.

The electronic timepiece described in JP-A-2012-202901 enables the user to change the speed at which the hands are driven between a high speed and a low speed by the user manipulating the crown while the hands are being driven rapidly. This enables shortening the time required to move the hands to the target time position by driving the hands at high speed when the hands must move a great distance. In addition, by changing the drive speed of the hands to a low speed when the hands are near the target time position, the user can easily adjust the hands to the target time position.

The user may also select a particular time zone with the electronic timepiece, and adjust the hand positions according to the time in the selected time zone. In this case, the controller of the electronic timepiece may calculate the amount the hands must be driven according to the time zone selected by the user, and drive the hands quickly to the target time position. As a result, the user does not need to manipulate the crown, for example, to stop the hands at the target time position.

In this situation the hands are preferably driven as fast as possible to shorten the time required to adjust the positions of the hands. With the electronic timepiece described in JP-A-2012-202901, however, the user must operate the crown to change the speed at which the hands are driven to high speed, and this complicates operation for the user.

### SUMMARY

An object of the present invention is to provide an electronic timepiece that improves operability when the user adjusts the positions of the hands.

An electronic timepiece according to the invention has an operating means (operator), hands, a drive means (driver) that drives the hands, and a controller that controls the driver in a first mode and a second mode. When controlled in the first mode, the driver moves the hands rapidly at a first speed, and stops the hands when a specific operation is performed with the operator while the driver is driving the hands rapidly at the first speed. When controlled in the second mode, the driver moves the hands rapidly at a second speed that is faster than the first speed, and stops the hands when the hands have moved to a specific position.

In this configuration, the driver drives the hands quickly at a first speed when controlled in a first mode, and stops the hands when a specific operation is performed on the operator while the hands are moving. In other words, in the first mode, the hands stop when the user executes a specific operation on the operating means (operator). Because the driver moves the hands rapidly in the first mode at a first speed that is slower than the second speed, the hands can be easily stopped at the target time position without changing the drive speed of the hands to a low speed.

In addition, when controlled in the second mode, the driver drives the hands quickly at a second speed that is faster than the first speed, and when the hands move to a specific position, stops the hands. As a result, in the second mode there is no need for the user to use the operator to stop the hands. Because the driver moves the hands rapidly in the second mode at a second speed that is faster than the first speed, the hands can be set to the target position in a short time without changing the drive speed of the hands to a high speed.

When the hands are driven quickly and the user manually stops the hands at the target position, this configuration can move the hands at a first speed that enables the user to easily stop the hands at the target position. When the stop position is already known, the hands can be moved at a second speed that is faster than the first speed so that the hands can be moved to the destination in a short time. As a result, the user does not need to change the driving speed of the hands, operability is improved for the user, and the hands can be moved efficiently.

In an electronic timepiece according to another aspect of the invention, the controller has a reference position setter configured to execute a reference position setting mode to set the hand to the reference position, and when the reference position setting mode executes, the controller controls the driver in the first mode.

In an electronic timepiece that acquires time information from an external device and automatically adjusts the time indicated by the hands according to the acquired time information, synchronizing the positions of the hands to the hand position counter corresponding to those hand positions is often necessary. In this case, the reference position setter can initialize the hand position counter to a value corresponding to the reference position by the user moving the hands to the reference position and then executing a reference position setting operation.

Because the controller in this configuration controls the driver in the first mode when reference position setting mode is executed, the hand is driven quickly at the first speed. The user can therefore easily adjust the positions of the hands to the reference position without changing the speed the hands are driven to a low speed.

In an electronic timepiece according to another aspect of the invention, the controller has a time zone selector configured to execute a time zone selection mode to select a time zone of a time the hand indicates, and when the time zone selection mode executes, the controller controls the driver in the second mode, and stops the hand at a position indicating a time based on the selected time zone.

When the time zone selection mode for selecting the time zone of the time indicated by the hands executes in this configuration, the controller controls the driver in the second mode, and stops the hands at the position indicating the time based on the selected time zone. As a result, when the time zone selection mode executes, there is no need for the user to stop the hands manually. Furthermore, because the hands are driven from the start at the high second speed when the time zone selection mode executes, the user can cause the hands to move in a short time to the position indicating the time based on the selected time zone without needing to change the speed of hand movement to a high speed.

An electronic timepiece according to another aspect of the invention preferably also has a receiver configured to receive a signal containing time information. The controller includes a reception time adjuster to execute a reception mode of receiving the signal by the receiver and adjusting a time the hand indicates; and when the reception mode executes, the controller controls the driver in the second mode, and stops the hand at a position indicating a time based on the received time information.

When the reception mode is executed in this aspect of the invention, the controller controls the driver in the second mode, and stops the hands at the position indicating time based on the received time information. As a result, as in the time zone selection mode, when the reception mode is executed, the user can cause the hands to move in a short time to the position indicating the time based on the received time information without needing to change the speed of hand movement to a high speed.

An electronic timepiece according to another aspect of the invention preferably also has a time display including a first time display with a first hand, and a second time display with a second hand. The driver includes a first driver to drive the first hand, and a second driver to drive the second hand. The controller includes a display controller configured to execute a time zone switching process that interchanges the times displayed by the first time display and the second time display; and when the time zone switching process executes, the controller controls the first driver and the second driver in the second mode.

In this aspect of the invention, when the display controller executes a time zone switching process to interchange the times displayed by the first time display and the second time display, the controller controls the first driver and the second driver in the second mode. As a result, as in the time zone selection mode and the reception mode, the user can interchange the time indicated by the first hands of the first time display with the time indicated by the second hands of the second time display without needing to change the speed the hands are driven to a high speed.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a front view of an electronic timepiece according to the invention.

FIG. 2 is a block diagram illustrating the configuration of the electronic timepiece according to a preferred embodiment of the invention.

FIG. 3 is a block diagram illustrating the configuration of storage in a preferred embodiment of the invention.

FIG. 4 is a flow chart showing a process whereby the controller controls a drive mechanism to drive the hands.

FIG. 5 shows operating modes in which the controller controls the drive mechanism.

FIG. 6 is a flow chart of a reference position setting process.

FIGS. 7A and 7B illustrate rapidly driving the hands in the reference position setting mode.

FIG. 8 is a flow chart of a time zone selection process.

FIGS. 9A and 9B illustrate rapidly driving the hands in the time zone selection mode.

FIG. 10 is a flow chart of a reception process.

FIGS. 11A-11C illustrate rapidly driving the hands in the reception mode.

FIG. 12 is a flow chart of a time zone switching process.

FIGS. 13A-13C illustrate rapidly driving the hands in the time zone switching mode.

### DESCRIPTION OF EMBODIMENTS

A preferred embodiment of the invention is described below with reference to the accompanying figures.

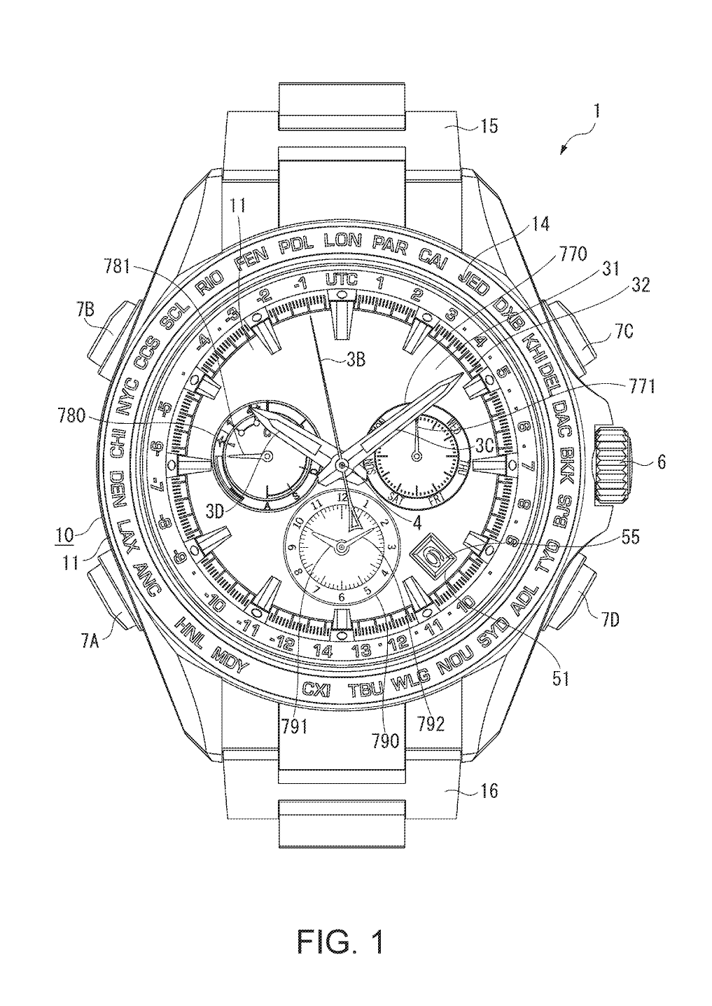

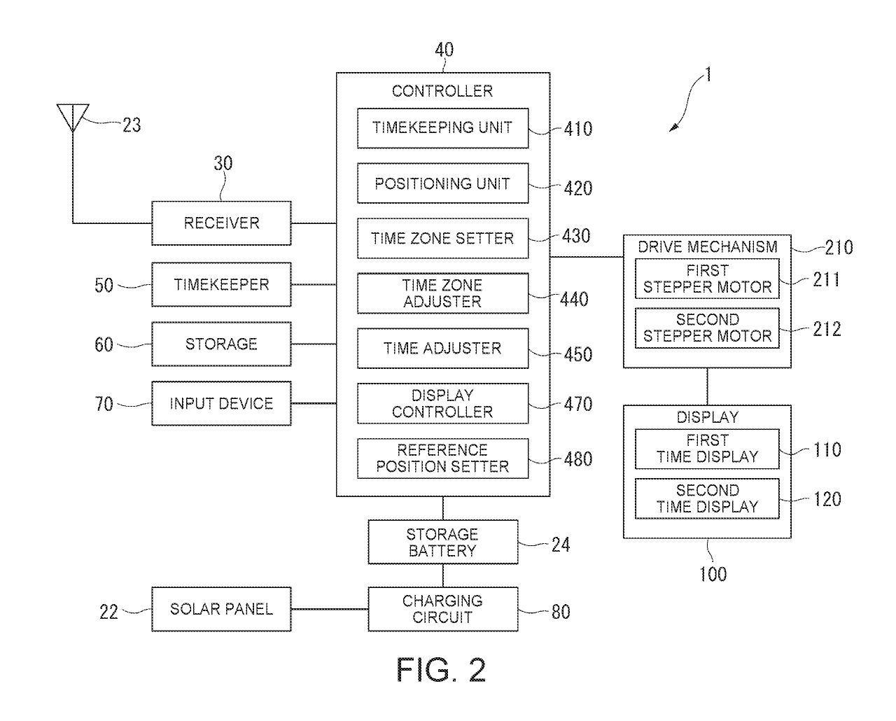

FIG. 1 is a front view of an electronic timepiece according to this embodiment of the invention, and FIG. 2 is a block diagram illustrating the configuration of the electronic timepiece 1.

The electronic timepiece 1 according to this embodiment is configured to receive satellite signals transmitted from multiple positioning information satellites such as GPS satellites or quasi-zenith satellites that orbit the Earth on specific known orbits, acquire satellite time information, and adjust internal time information of the electronic timepiece 1.

Electronic Timepiece

As shown in FIG. 1, the electronic timepiece 1 has an external case 10 that houses a dial 11, a movement (not shown in the figure), a planar antenna planar antenna 23 (see FIG. 2), and a storage battery 24 (see FIG. 2). The external case 10 has a basically cylindrical shape, and is made from stainless steel (SUS), titanium, or other metal. A crystal 31 is attached by a bezel 14 to cover the opening on the face side of the external case 10. The bezel 14 is made from a metal such as stainless steel, a titanium alloy, aluminum, or brass, and has city markers used to select a time zone.

The electronic timepiece 1 also has external operators such as a crown 6 and four buttons 7A, 7B, 7C, 7D, and a band connected to the external case 10.

The band includes a first band 15 that connects to the external case 10 at the 12:00 side, a second band 16 that connects to external case 10 at the 6:00 side, and a clasp not shown. The first band 15 and second band 16 are metal bands each including an end piece made of titanium or other metal that attaches to the external case 10, and multiple links. Note that the band is not limited to a metal band, and may be a leather band or a plastic band, for example.

The dial 11 is a round disk made of polycarbonate or other electrically non-conductive material. In the center of the dial 11 is disposed a center arbor 4, and a second hand 3B, minute hand 3C, and hour hand 3D are attached to the center arbor 4. A dial ring 32 is attached around the outside edge of the dial 11, and a scale of sixty minute markers is formed around the inside circumference of the dial ring 32. Using this scale, the secondhand 3B indicates the second of a first time, which is normally the local time, the minute hand 3C indicates the minute of the first time, and the hour hand 3D indicates the hour of the first time. Hands 3B to 3D are examples of first hands, and the dial ring 32 and hands 3B to 3D together configure a first time display 110, in this embodiment of the invention.

Note that because the second of the first time is the same as the second of the second time, the user can also know the second of the second time by looking at the second hand 3B.

The dial 11 also has three windows (subdials). As shown in FIG. 1, relative to the center of the dial 11, a round first subdial 770 and a small hand 771 are disposed at 3:00, a round second subdial 780 and small hand 781 are disposed at 9:00, and a round third subdial 790 and small hands 791 and 792 are disposed at 6:00.

A rectangular date window 51 is disposed relative to the center of the dial 11 in the direction between 4:00 and 5:00 (at the 4:30 position). A date indicator 55 is disposed on the back cover side of the dial 11, and the date indicator 55 can be seen through the date window 51.

In this embodiment, the small hand 771 of the first subdial 770 is a day hand indicating the day of the week, and the small hand 781 of the second subdial 780 is a mode indicator for indicating other information. The hands 791, 792 of the third subdial 790 are the hour hand and minute hand of a small clock for indicating the home time or local time, for example.

The second subdial 780 has markers pointed to by a mode indicator, small hand 781 in this example, including a power indicator for indicating the power reserve of the storage battery 24, a daylight saving time mode setting, airplane mode setting, and a GPS satellite signal reception mode setting.

The power indicator is a band extending from 9:00 to 7:00 on the second subdial 780, the 9:00 position indicating a full charge (F), and the 7:00 position indicating an empty charge (E).

The markers for indicating the daylight saving time mode setting include an A at 6:00, an S at approximately 5:00, and a D at approximately 4:00.

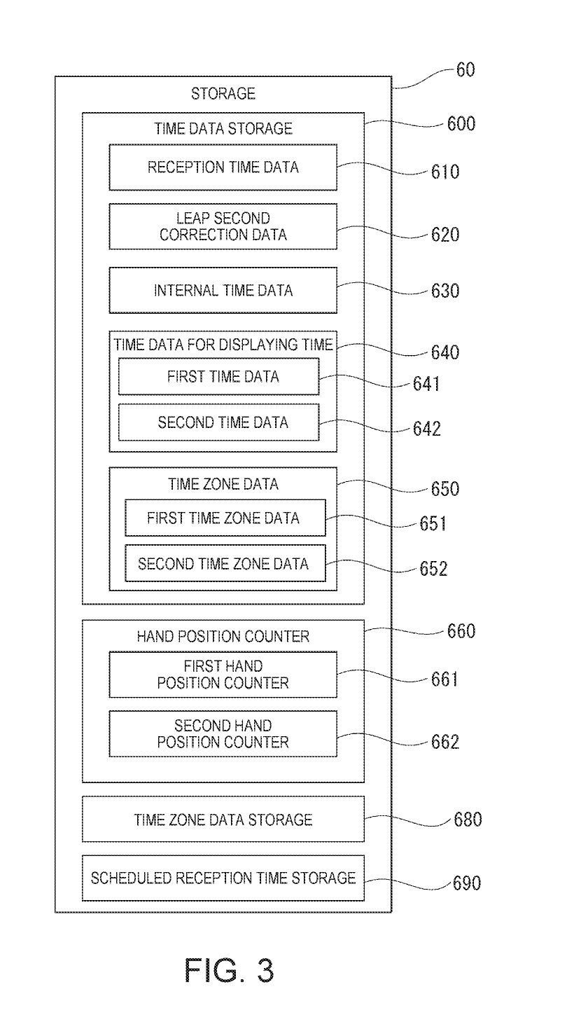

The ‘A’ means an AUTO mode for automatically setting daylight saving time. The AUTO mode is a mode for automatically changing the daylight saving time setting using data stored in the time zone data storage 680 (see FIG. 3) of the storage 60 in the electronic timepiece 1 when positioning information is acquired from satellite signals. As a result, a database relationally storing location information, time zone information related to the location information, and daylight saving time setting data appropriate to the location information, is stored in the time zone data storage 680 of the electronic timepiece 1.

The ‘S’ indicates a STD mode (standard mode) for always displaying the standard time in response to a manual setting.

The ‘D’ means the daylight saving time (DST) mode, and indicates a mode for always displaying daylight saving time in response to a manual setting.

An airplane icon indicating the airplane mode is displayed at the 10:00 position of the second subdial 780, a ‘1’ marker indicating the timekeeping mode of the reception mode is shown at approximately 11:00, and a ‘4+’ marker indicating the navigation mode of the reception mode is shown at approximately 12:00. An ‘L’ marker indicating a reception mode for acquiring leap second information is shown at approximately 1:00.

A scale dividing the inside circumference into sixty markers is formed on the inside circumference side of the third subdial 790. Using this scale, the small hand 791 indicates the hour of a second time, which is normally the home time, and the small hand 792 indicates the minute of the second time. The hands 791, 792 are therefore an example of second indicators, and the third subdial 790 and hands 791, 792 together configure a second time display 120, in this embodiment of the invention.

The second hand 3B, minute hand 3C, and hour hand 3D, hands 771, 781, 791, 792, and date indicator 55, are driven through a drive mechanism 210 (see FIG. 2) described below.

Configuration of the Electronic Timepiece

As shown in FIG. 2, the electronic timepiece 1 has a solar panel 22, storage battery 24, receiver 30 (reception means), controller 40 (control means), dial 50, storage 60, input device 70 (operating means), charging circuit 80, display 100 (time display means), and drive mechanism 210 (drive means).

The charging circuit 80 supplies power generated by the solar panel 22 to the storage battery 24 to charge the storage battery 24.

The drive mechanism 210 includes a first stepper motor 211 for driving the minute hand 3C and hour hand 3D, and a second stepper motor 212 for driving the hands 791, 792. The drive mechanism 210 is also configured with a stepper motor (not shown in the figure), wheel trains (not shown in the figure), and drive circuit (not shown in the figure) for driving the second hand 3B, small hand 771, small hand 781, and date indicator 55. The drive mechanism 210 drives hands 3B-3D, 771, 781, 791, 792 and date indicator 55 through these stepper motors and wheel trains.

Note that the drive mechanism 210 is an example of a drive means (driver) of the invention. The first stepper motor 211 and second stepper motor 212 are examples of a first drive means (first driver) and second drive means (second driver) of the invention.

The display 100 includes a first time display 110 and a second time display 120. The display 100 is therefore an example of a time display means (time display) of the invention.

Input Device

The input device 70 includes the crown 6 and four buttons 7A, 7B, 7C, 7D. When the input device 70 is operated, the operating mode corresponding to the manual operation is executed. More specifically, the input device 70 including the crown 6 and four buttons 7A, 7B, 7C, 7D is an example of an operating means (operator) of the invention.

More specifically, when the crown 6 is pulled out two stops, a time zone selection mode (second time display) enabling the user to select a time zone is executed.

When the crown 6 is pulled out two stops and button 7D is pushed for three seconds or more, a reference position setting mode (second time display) for setting the reference position of the hands 791, 792 is executed.

When the crown 6 is a the zero (0) stop and button 7C is pushed for greater than or equal to 3 seconds and less than 6 seconds, the reception process executes in the timekeeping mode, and if the button 7C is pushed for six seconds or more, the reception process executes in the navigation mode.

If button 7C and button 7D are pushed simultaneously for three seconds or more, a time zone switching mode that interchanges the first time data 641 displayed in the first time display 110, and second time data 642 displayed in the second time display 120, is executed.

These operating modes are described in detail below.

The operating modes executed when the buttons 7A to 7D are pushed are not limited to the foregoing, and may be set desirably according to the functions of the electronic timepiece 1.

Receiver

When the receiver 30 is driven by the controller 40, the receiver 30 receives the radio waves of satellite signals transmitted from GPS satellites through the planar antenna 23. In other words, the receiver 30 is an example of a receiving means (receiver) of the invention.

When the receiver 30 successfully receives the radio waves of satellite signals, it sends the acquired orbit information and GPS time information, for example, to the controller 40. If the receiver 30 fails to receive the radio waves of satellite signals, and the receiver 30 reports a reception failure to the controller 40. Note that the configuration of the receiver 30 is the same as the configuration of a GPS reception circuit known from the literature, and further description thereof is omitted.

Timekeeping Device

The timekeeper 50 includes a crystal oscillator, and updates time data using a reference signal based on the pulse signal from the crystal oscillator.

Storage

FIG. 3 is a block diagram showing the configuration of the storage 60.

The storage 60 is configured with RAM (Random Access Memory) and ROM (Read Only Memory), and as shown in FIG. 3 includes a time data storage 600, hand position counter 660, time zone data storage 680, and scheduled reception time storage 690. Note that the storage 60 is an example of a storage means (storage) of the invention.

Reception time data 610, leap second correction data 620, internal time data 630, time data for displaying time 640, and time zone data 650 are stored in the time data storage 600.

Time information (GPS time) acquired from satellite signals is stored in the reception time data 610. The reception time data 610 is normally updated at a one-second interval by the timekeeper 50, and when a satellite signal is received, is corrected based on the acquired time information (GPS time).

Data about at least the current leap second is stored in the leap second correction data 620. More specifically, the current leap second value, the week number of the leap second event, the day number of the leap second event, and the future leap second value are contained on page 8 of subframe 4 in the satellite signals as data related to the leap second. Of this information, at least the current leap second value is stored in the leap second correction data 620.

Internal time information is stored in the internal time data 630. This internal time information is updated based on GPS time stored in the reception time data 610, and the current leap second value stored in the leap second correction data 620. More specifically, UTC (Coordinated Universal Time) is stored in the internal time data 630. When the reception time data 610 is updated by the timekeeper 50, this internal time information is also updated.

Time data adding the time zone data (time zone information, time difference information) in the time zone data 650 to the internal time information in the internal time data 630 is stored as the time data for displaying time 640.

In this embodiment, the time data for displaying time 640 includes first time data 641 and second time data 642, and the time zone data 650 includes first time zone data 651 and second time zone data 652.

The first time data 641 stores time information adding the time zone data (time difference information) in the first time zone data 651 to the internal time information of the internal time data 630. The first time zone data 651 is set by the time zone data when the time zone is selected by the user, and when time zone information is received in the navigation mode.

The second time data 642 stores time information adding the time zone data in the second time zone data 652 to the internal time information of the internal time data 630. The second time zone data 652 is set by the time zone data selected by the user.

The hand position counter 660 includes a first hand position counter 661 and second hand position counter 662.

A hand position count corresponding to the positions of the hands 3B to 3D that indicate the time in the first time display 110 is stored in the first hand position counter 661.

A hand position count corresponding to the positions of the hands 791, 792 that indicate the time in the second time display 120 is stored in the second hand position counter 662.

The time zone data storage 680 relationally stores location information (latitude and longitude), time zone information (time difference information) corresponding to the location information, and daylight saving time setting information. When location information is acquired in the navigation mode, the controller 40 is configured to acquire time zone data and daylight saving time data based on the location information (latitude and longitude).

The time zone data storage 680 also stores time zone city names relationally to the time zone data. This enables the time zone setter 430 of the controller 40 to search for the city name set by the user in the time zone data storage 680, acquire the time zone data for that city name, and set the first time zone data 651 or second time zone data 652.

The scheduled reception time at which the timekeeping unit 410 executes the scheduled reception process is stored in the scheduled reception time storage 690. The scheduled reception time in this example is the time when reception was successful in response to the user operating the button 7C to manually start satellite signal reception.

Controller

Referring again to FIG. 2, the controller 40 is configured with a CPU that controls the electronic timepiece 1. The controller 40 includes a timekeeping unit 410, positioning unit 420, time zone setter 430, time zone adjuster 440, time adjuster 450, display controller 470, and reference position setter 48. Note that the controller 40 is an example of a control means (controller) of the invention.

Timekeeping Unit

The timekeeping unit 410 operates the receiver 30 to execute the reception process in the timekeeping mode. This embodiment can execute the timekeeping mode reception process as either an automatic reception process or a manual reception process.

There are two types of automatic reception processes, a scheduled automatic reception process and a light-driven automatic reception process. More specifically, if the internal time data 630 kept by the timekeeping unit 410 reaches a scheduled reception time stored in the scheduled reception time storage 690, the timekeeping unit 410 operates the receiver 30 to execute the scheduled automatic reception process of the timekeeping mode.

If the output voltage or the output current of the solar panel 22 is greater than or equal to a set threshold, and the timekeeping unit 410 determines the solar panel 22 is exposed to sunlight outdoors, the timekeeping unit 410 operates the receiver 30 to execute the light-based automatic reception process of the timekeeping mode.

The number of times the automatic reception process executes may also be limited so that either the scheduled automatic reception process or the light-based automatic reception process executes only once a day.

Furthermore, if the user pushes button 7C of the input device 70 (for greater than or equal to 3 seconds and less than 6 seconds) to manually start the reception process, the reception process executes in the timekeeping mode. When the reception process executes in the timekeeping mode, the timekeeping unit 410 operates the receiver 30 to execute a manual reception process.

The timekeeping unit 410 operates the receiver 30 to lock onto at least one GPS satellite or quasi-zenith satellite, receive satellite signals transmitted from that positioning information satellite, and acquire time information.

Positioning Unit

When the user pushes the button 7C of the input device 70 (for 6 seconds or more) to force reception, the positioning unit 420 operates the receiver 30 to execute the reception process in the navigation mode.

The controller 40 thus controls reception in the timekeeping mode by the timekeeping unit 410, or the navigation mode by the positioning unit 420, according to how long the button 7C is pushed.

The timekeeping mode, navigation mode, and leap second reception mode may also be previously selected so that the reception process executes in the selected mode when the automatic reception process (scheduled automatic reception process or light-based automatic reception process) executes.

When the reception process starts in the navigation mode, the positioning unit 420 locks onto at least three, and preferably four or more, GPS satellites with the receiver 30, receives satellite signals from the GPS satellites, and calculates and acquires location information. The positioning unit 420 can also simultaneously acquire time information from the received satellite signals.

This embodiment of the invention thus has both a timekeeping mode and a navigation mode, and can acquire time information in both modes.

Time Zone Setter

When location information is successfully acquired by the positioning unit 420, the time zone setter 430 sets the time zone data based on the acquired location information (latitude and longitude). More specifically, the time zone setter 430 selects and acquires time zone data (time difference information) corresponding to the location information from the time zone data storage 680, and stores the time zone data in the first time zone data 651.

For example, because Japan Standard Time (JST) is nine hours ahead of UTC (UTC+9), when the location information acquired by the positioning unit 420 identifies a location in Japan, the time zone setter 430 reads the time difference to Japan Standard Time (+9 hours) from the time zone data storage 680, and stores the time difference in the first time zone data 651.

When time difference information or city name information is selected by operating the input device 70, the time zone setter 430 executes a time zone selection mode storing the time zone data corresponding to the selected time difference information or city name information in the first time zone data 651 or second time zone data 652.

Time Zone Adjuster

The time zone adjuster 440 corrects the time data for displaying time 640 in an automatic correction mode and a time zone selection mode.

When the time zone information is set based on the location information (latitude and longitude) the time zone setter 430 acquired in the automatic correction mode, the time zone adjuster 440 corrects the time data for displaying time 640 using the time zone data. More specifically, the time zone adjuster 440 corrects the first time data 641 using the first time zone data 651, and corrects the second time data 642 using the second time zone data 652. As a result, the first time data 641 and second time data 642 are set to the time adding the time zone data to the internal time data 630, which is UTC.

In the time zone selection mode, the user selects the desired time zone, and the time zone adjuster 440 corrects the time data for displaying time 640 using the time zone data for the selected time zone.

The time zone setter 430 and time zone adjuster 440 therefore configure a time zone selector of the invention.

Time Adjuster

When acquiring time information is successful in the reception process of the timekeeping unit 410 or positioning unit 420, the time adjuster 450 adjusts the reception time data 610 based on the acquired time information. As a result, the internal time data 630, first time data 641, and second time data 642 are adjusted. More specifically, the timekeeping unit 410, positioning unit 420, and time adjuster 450 configure the reception time adjusting unit (reception time adjustor) of the invention that executes the timekeeping mode and navigation mode as reception modes for correcting the time indicated by the hands 3B to 3D, and hands 791, 792.

Display Controller

The display controller 470 controls the first stepper motor 211 to display the time information of the first time data 641 by the minute hand 3C and hour hand 3D, and controls the second stepper motor 212 to display the time information of the second time data 642 by the hands 791, 792.

When button 7C and button 7D are pushed for three seconds or more, the display controller 470 goes to the time zone switching mode. In this case, the display controller 470 controls the first stepper motor 211 and second stepper motor 212 of the drive mechanism 210 to execute the time zone switching process interchanging the times indicated by the first time display 110 and second time display 120.

More specifically, the time zone switching mode is an example of the display interchanging mode of the invention.

When the crown 6 is pulled out to the second stop and the button 7D is pushed for three seconds or more, the reference position setting mode (second time display) is executed. In this case, the display controller 470 controls the second stepper motor 212 of the drive mechanism 210 according to operation of the crown 6 to drive the hands 791, 792.

Reference Position Setter

The reference position setter 480 executes a reference position setting mode that synchronizes the positions of the hands 791, 792 in the second time display 120 with the second hand position counter 662, that is, initializes the positions of the hands (matches the hand positions to the counter).

More specifically, when the reference position setting mode (second time display) executes, the user manipulates the crown 6 to set the hands 791, 792 to the reference position, such as the 00:00 position. In this event, the display controller 470 controls the second stepper motor 212 of the drive mechanism 210 to move the hands 791, 792. If the hands 791, 792 are set to 00:00 and the button 7A is pushed for three seconds or more, the reference position setter 480 executes a reference position setting process of initializing the second hand position counter 662 that tracks the positions of the hands 791, 792. As a result, the positions of the hands 791, 792 and the hand position counter corresponding to the hand positions are initialized.

The reference position setter 480 also synchronizes the positions of the hands 3B to 3D in the first time display 110 with the first hand position counter 661 (matches the hand positions to the counter).

Controller Operation

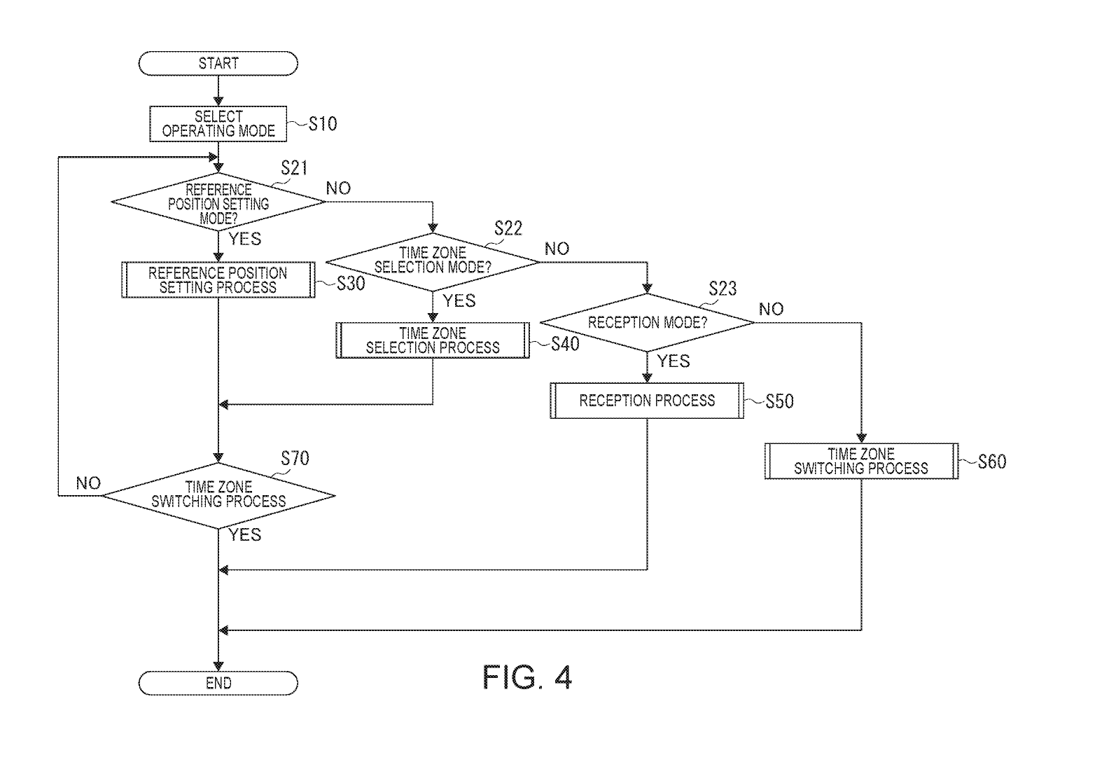

FIG. 4 is a flow chart of the process of the controller 40 controlling the first stepper motor 211 and second stepper motor 212 of the drive mechanism 210 to drive the hands 3C, 3D, 791, 792.

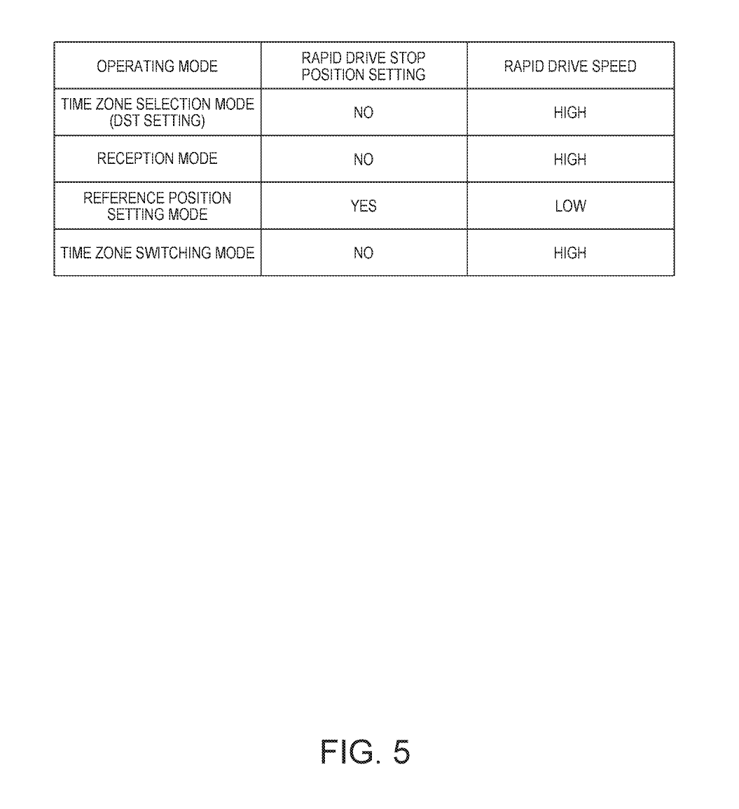

FIG. 5 illustrates the operating modes whereby the controller 40 controls the drive mechanism 210.

As shown in FIG. 5, the controller 40 in this embodiment is configured to enable selecting, as the operating mode for controlling the drive mechanism 210, a time zone selection mode, reception mode, reference position setting mode, and a time zone switching mode.

Of these modes, the reference position setting mode requires manually setting the stop positions of the hands 791, 792 when rapidly driving the hands, and the rapid driving speed is set to a low speed, as described below.

In contrast, in the time zone selection mode, reception mode, and time zone switching mode, manually setting the stop positions of the hands 791, 792 when rapidly driving the hands is not required, and the rapid driving speed is set to a high speed, as described below.

Note that the operating modes are not limited to the foregoing, and may also include being able to select, for example, a manual time setting mode in which the time indicated by the hands is adjusted by manually operating the input device 70, or a positioning mode that drives the second hand 3B to indicate a position indicating a previously set direction.

Furthermore, a configuration enabling selecting all of the foregoing operating modes is not necessary, and a configuration enabling selecting the reference position setting mode and time zone selection mode, for example, and a configuration enabling selecting an operating mode requiring manually setting the stop position of the hands, or an operating mode not requiring manually setting the stop position of the hands, are conceivable.

Referring again to FIG. 4, the controller 40 selects the operating mode for controlling the drive mechanism 210 according to operation of the input device 70 such as described above (S10).

Next, the controller 40 determines if the selected operating mode is the reference position setting mode (S21).

If S21 returns YES, the controller 40 executes the reference position setting process S30 described below, and if S21 returns No, determines if the selected operating mode is the time zone selection mode (S22).

If S22 returns YES, the controller 40 executes the time zone selection process S40 described below, and if S22 returns No, determines if the selected mode is a reception mode (S23).

If S23 returns YES, the controller 40 executes the reception process S50 described below, and if S23 returns No, executes the remaining time zone switching process S60 of the four modes shown in FIG. 5.

Reference Position Setting Mode

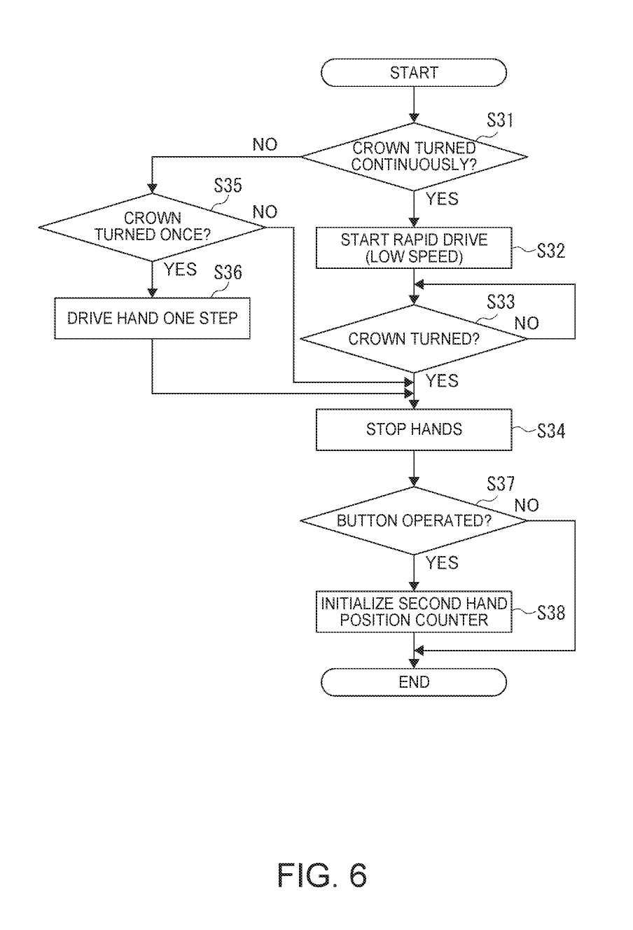

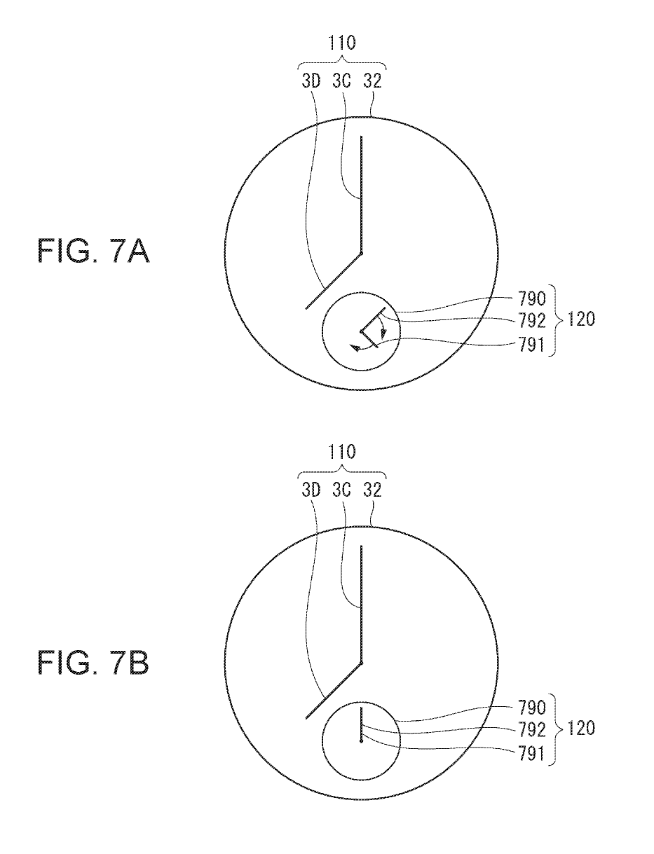

FIG. 6 is a flow chart of the reference position setting process S30, and FIGS. 7A and 7B illustrate rapidly driving the hands 791, 792 in the reference position setting mode.

As shown in FIG. 6, when the reference position setting process S30 executes, the reference position setter 480 of the controller 40 determines whether or not the crown 6 was turned continuously (S31).

In S31, if the rotation detector (not shown in the figure) that detects rotation of the crown 6 detects rotation of the crown 6 twice within a previously set time, the rotation detector determines the crown 6 was turned continuously.

If S31 returns Yes, the display controller 470 controls the second stepper motor 212 of the drive mechanism 210 to start rapidly advancing the hands 791, 792 (S32).

As shown in FIG. 7A, in this embodiment the hands 791, 792 are driven forward. At this time, the display controller 470 outputs a continuous drive pulse train to the second stepper motor 212. The frequency of the continuous pulse train in the reference position setting mode is set to a lower frequency (such as 16 Hz) than the continuous drive pulse train in the time zone selection mode, reception mode, and time zone switching mode described below. As a result, in the reference position setting mode the hands 791, 792 are driven at a low first speed.

More specifically, the control mode the controller 40 uses to control the second stepper motor 212 of the drive mechanism 210 in the reference position setting mode is an example of a first mode of the invention.

In this embodiment, the small hand 792 moves six degrees (one minute) in one step (pulse). As described above, because a scale dividing the inside circumference into 60 markers is formed on the inside circumference side of the third subdial 790, when the frequency of the continuous drive pulse train is set to 16 Hz, the small hand 792 moves one revolution around the scale on the third subdial 790 in 3.75 seconds.

Note that the direction in which the hands 791, 792 are driven is not limited to forward, and the hands may be driven in reverse. The hands 791, 792 may also be driven in the direction requiring the least number of steps to move to a specific position. The direction in which the hands 791, 792 are driven is the same in the time zone selection mode, reception mode, and time zone switching mode below.

Referring again to FIG. 6, the reference position setter 480 determines if the crown 6 turned (S33).

If S33 returns No, the display controller 470 controls the second stepper motor 212 until rotation of the crown 6 is detected, and then drives the hands 791, 792 rapidly.

Once S33 returns Yes, the display controller 470 controls the second stepper motor 212 to stop the hands 791, 792 (S34).

In this way, driving the hands 791, 792 stops once rotation of the crown 6 is detected while the hands 791, 792 are being driven rapidly at a first speed in the reference position setting mode. As a result, as shown in FIG. 7B, timed to the hands 791, 792 moving the 00:00 position, the user must turn the crown 6 and set the stop position of the hands 791, 792 manually.

Note that the operation of the user turning the crown 6 to stop driving the hands 791, 792 is an example of a specific operation of the invention.

When S31 returns No, the reference position setter 480 determines if the crown 6 was turned a single revolution (S35). In this example in S35, if the rotation detector not shown that detects rotation of the crown 6 detects that the crown 6 was turned only once within the specific time, the reference position setter 480 determines the crown 6 was turned only once.

When S35 returns Yes, the display controller 470 controls the second stepper motor 212 to drive the hands 791, 792 one step (S36). In this embodiment as described above, the small hand 792 moves six degrees (one minute) per pulse. When the hands 791, 792 are driven one step in S36, the display controller 470 controls the second stepper motor 212 to stop driving the hands 791, 792 (S34).

As a result, the hands 791, 792 can be driven one step at a time in the reference position setting mode in this embodiment. As a result, the hands 791, 792 can be driven rapidly to near the 00:00 position, then the hands 791, 792 can be driven one step at a time to set the hands 791, 792 to the 00:00 position.

When S35 returns No, the hands 791, 792 are stopped (S34). For example, if the hands 791, 792 have moved to the reference position at 00:00, the hands 791, 792 stop at that position without the user needing to operate the crown 6.

Next, the reference position setter 480 determines whether or not the button 7A was pushed for three seconds or more (S37).

If S37 returns Yes, the reference position setter 480 initializes the second hand position counter 662 (S38), and ends the reference position setting process.

If S37 returns No, the reference position setting process stops immediately.

Referring again to FIG. 4, after the reference position setting process S30 ends, the controller 40 determines if an operation ending the operating mode was performed with the input device 70 (S70). More specifically, the controller 40 determines if the crown 6 was reset to the zero stop position.

If S70 returns No, the controller 40 returns to S21, and repeats the process. As a result, the hands 791, 792 are rapidly driven and moved to a position near the reference position at 00:00 in S32-S34. Control then returns to S21, the reference position setting process S30 repeats, and in steps S35-S37, the hands 791, 792 are driven one step at a time to set the hands 791, 792 to the 00:00 position.

More specifically, because the hands 791, 792 can be both driven rapidly and then one step at a time, the user can easily set the hands 791, 792 to the reference position.

When S70 returns Yes, the process ends.

Time Zone Selection Process

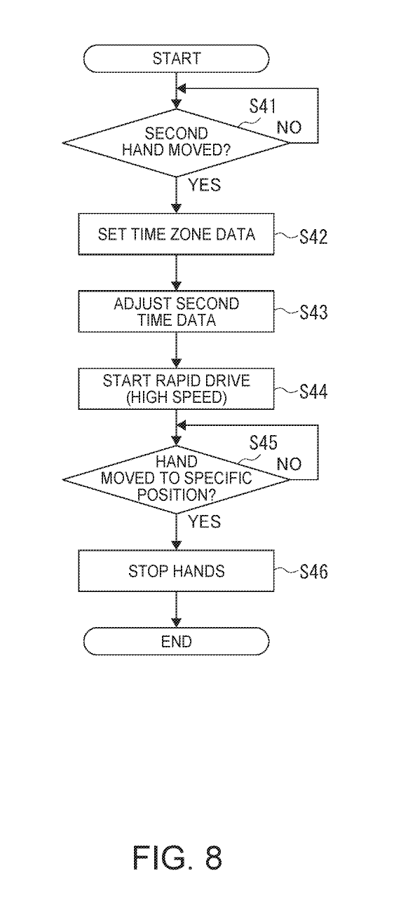

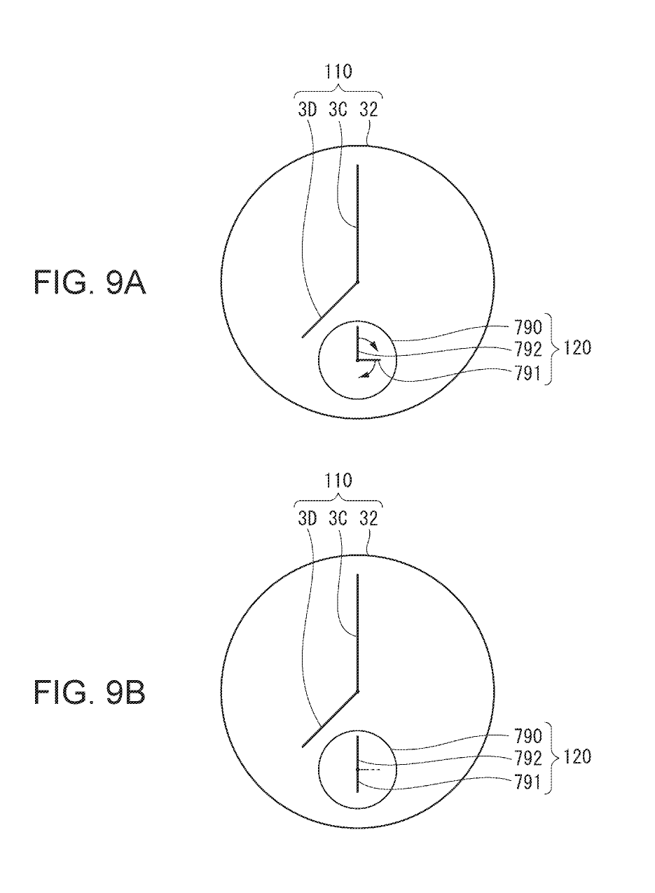

FIG. 8 is a flow chart of the time zone selection process S40, and FIGS. 9A and 9B illustrate movement of the hands 791, 792 in the time zone selection mode.

As shown in FIG. 8, when the time zone selection process S40 executes, the time zone setter 430 determines whether or not the second hand 3B moved as a result of an input device 70 operation (S41).

If S41 returns No, the time zone setter 430 waits until the second hand 3B moves.

If S41 returns Yes, the time zone setter 430 executes the time zone selection mode enabling setting the time zone data corresponding to the city name information indicated by the second hand 3B from among the city name information on the bezel 14 to the second time zone data 652 (S42).

The time zone adjuster 440 then uses the second time zone data 652 to adjust the second time data 642 (S43). As a result, the second time data 642 is sequentially adjusted as the second hand 3B moves.

As shown in FIG. 9A, rapidly driving the hands 791, 792 starts while the second hand 3B is moving (S44). In this example, when the second hand 3B finally reaches the desired position, the time zone adjuster 440 changes the second time data 642 from 3:00 to 6:00 based on the setting in the second time zone data 652.

When the second time data 642 is adjusted, the display controller 470 outputs a continuous drive pulse train to the second stepper motor 212. The frequency of the continuous drive pulse train in the time zone selection mode is set to a higher frequency (such as 100 Hz) than the continuous drive pulse train in the reference position setting mode described above. As a result, in the time zone selection mode, the hands 791, 792 are driven rapidly at a high second speed.

The control mode in which the controller 40 controls the second stepper motor 212 of the drive mechanism 210 in the time zone selection mode is an example of a second mode of the invention.

Note also that as described above, the small hand 792 moves six degrees (one minute) in one step (pulse). As a result, when the frequency of the continuous drive pulse train is set to 100 Hz, the small hand 792 moves one revolution around the scale in the third subdial 790 in 0.6 second.

Referring again to FIG. 8, the display controller 470 determines if the hands 791, 792 moved to a specific position, that is, to the position indicating 6:00 in this example (S45). More specifically, the display controller 470 calculates the number of steps required for the hands 791, 792 to move from the position at 3:00 before the time zone was selected to the selected time zone position of 6:00. The display controller 470 determines whether or not the hands 791, 792 moved to the specific position by determining if the number of drive pulses required to move the calculated number of steps was output.

If S45 returns No, the display controller 470 continues driving the hands 791, 792 rapidly until the hands 791, 792 are determined to have reached the specific position.

If S45 returns Yes, that is, if the hands 791, 792 have moved to the position indicating 6:00, the time based on the selected time zone, as shown in FIG. 9B, the display controller 470 controls the second stepper motor 212 and stops the hands 791, 792 (S46).

As described above, in the time zone selection mode, which does not require manually setting the stop position of the hands 791, 792, the hands 791, 792 are driven at high speed without the user needing to change the drive speed of the hands 791, 792. As a result, the hands 791, 792 can be moved in a short time to the position indicating the time based on the selected time zone.

Referring again to FIG. 4, after the time zone selection process S40 ends, the controller 40 determines if an operation ending the operating mode was performed with the input device 70 (S70).

If S70 returns No, the controller 40 returns to S21 and S22, and repeats the process. As a result, if the user has selected yet another time zone, steps S41-S46 repeat, and the hands 791, 792 can be moved to the position indicating the time based on the selected time zone.

When S70 returns Yes, the process ends.

Reception Process

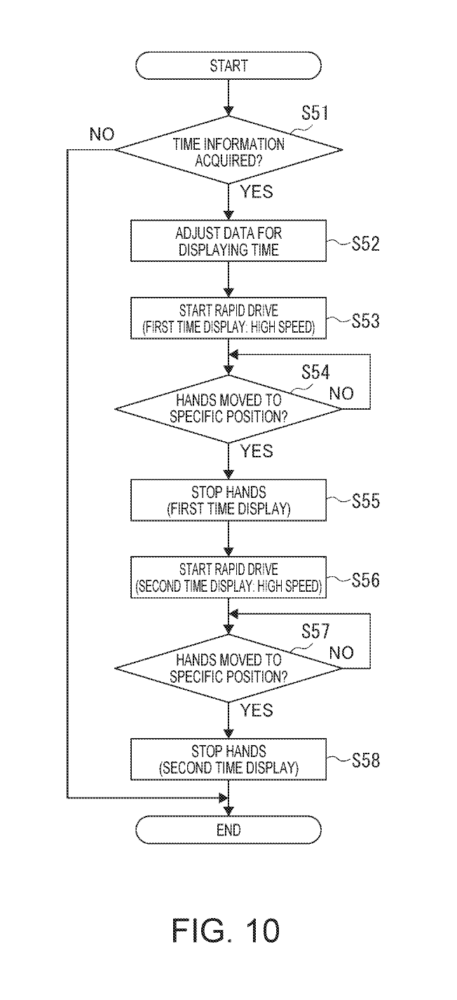

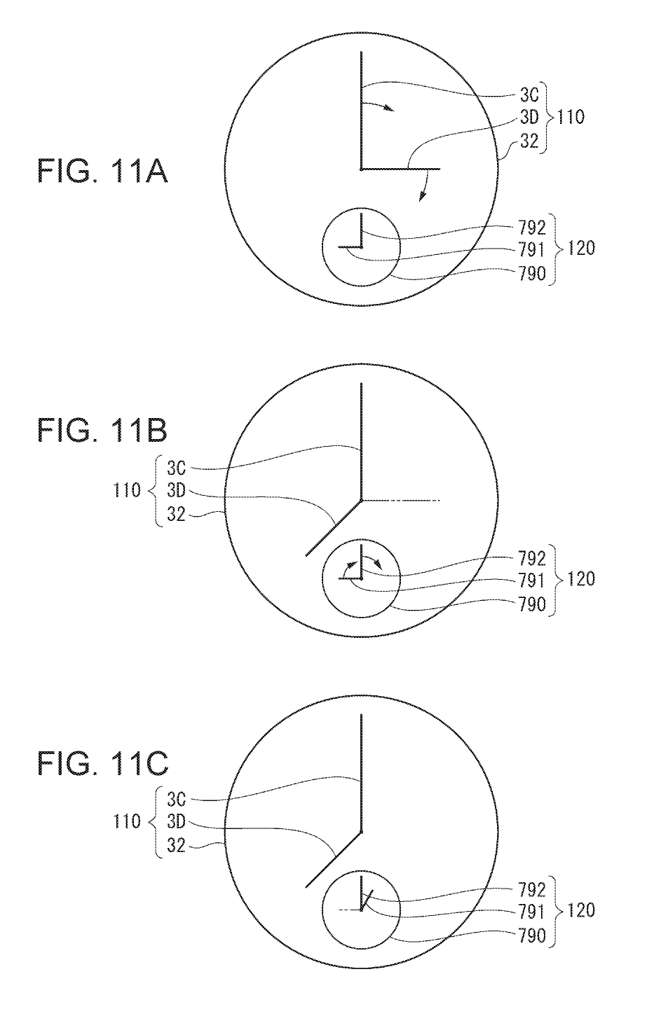

FIG. 10 is a flow chart of the reception process S50, and FIGS. 11A-11C illustrate rapidly driving the hands 3C, 3D, 791, 792 in the reception mode.

As shown in FIG. 10, when the reception process S50 executes, the timekeeping unit 410 executes the reception mode in the timekeeping mode, and determines whether or not time information was acquired from a satellite signal (S51).

If S51 returns No because the receiver 30 could not receive a satellite signal, for example, the reception process ends.

If S51 returns Yes, the time adjuster 450, based on the time information acquired by the timekeeping unit 410, adjusts the first time data 641 and second time data 642 of the time data for displaying time 640 (S52). In this example, the first time data 641 is adjusted from 3:00 to 7:00, and the second time data 642 is adjusted from 9:00 to 13:00.

Note that step S51 is not limited to the timekeeping unit 410 acquiring time information from satellite signals in the timekeeping mode, and time information may be acquired from satellite signals by the positioning unit 420 in the positioning mode.

Next, based on the first time data 641, the display controller 470 controls the first stepper motor 211 of the drive mechanism 210, and starts rapidly driving the minute hand 3C and hour hand 3D of the first time display 110 (S53). At this time, the first stepper motor 211 drives the hands 3C, 3D at a high speed.

The display controller 470 then determines if the hands 3C, 3D moved to the specific position (S54). In this example as shown in FIG. 11A and FIG. 11B, the display controller 470 determines if the hands 3C, 3D moved from the position indicating 3:00 to the position indicating 7:00.

Returning to FIG. 10, if S54 returns No, the display controller 470 continues driving the hands 3C, 3D rapidly until the hands 3C, 3D are determined to have reached the specific position.

When S54 returns Yes, that is, when the hands 3C, 3D have moved to the position indicating 7:00 as shown in FIG. 11B, the display controller 470 controls the first stepper motor 211 to stop the hands 3C, 3D (S55).

Next, based on the corrected second time data 642, the display controller 470 controls the second stepper motor 212 of the drive mechanism 210 to start rapidly driving the hands 791, 792 of the second time display 120 (S56). The display controller 470 therefore outputs a continuous drive pulse train to the second stepper motor 212. The frequency of the continuous drive pulse train in the reception mode is set the same as in the time zone selection mode, that is, a high frequency (in this example, 100 Hz). As a result, in the reception mode, the hands 791, 792 are driven rapidly at a high second speed.

More specifically, the control mode in which the controller 40 controls the second stepper motor 212 of the drive mechanism 210 in the reception mode is an example of a second mode of the invention.

The display controller 470 then determines whether or not the hands 791, 792 have moved to the specific position (S57). In this example, as shown in FIG. 11B and FIG. 11C, the display controller 470 determines if the hands 791, 792 have moved to the position indicating 13:00, which is the time based on the received time information. More specifically, the display controller 470 calculates the number of steps required for the hands 791, 792 to move from the position at 9:00 before the time zone was selected, to the corrected position at 13:00. The display controller 470 determines whether or not the hands 791, 792 moved to the specific position by determining if the number of drive pulses required to move the calculated number of steps was output.

Returning to FIG. 10, when S57 returns No, the display controller 470 continues driving the hands 791, 792 rapidly until it determines the hands 791, 792 have moved to the specific position.

If S57 returns Yes, that is, if the hands 791, 792 have moved to the position indicating 13:00 as shown in FIG. 11C, the display controller 470 controls the second stepper motor 212 to stop the hands 791, 792 (S58).

Referring again to FIG. 4, when the reception process S50 ends, processing ends.

As in the time zone selection mode described above, the hands 791, 792 can be moved in a short time in the reception mode, which does not require manually setting the stop position of the hands 791, 792, to the position indicating the time based on the received time information.

Time Zone Switching Process

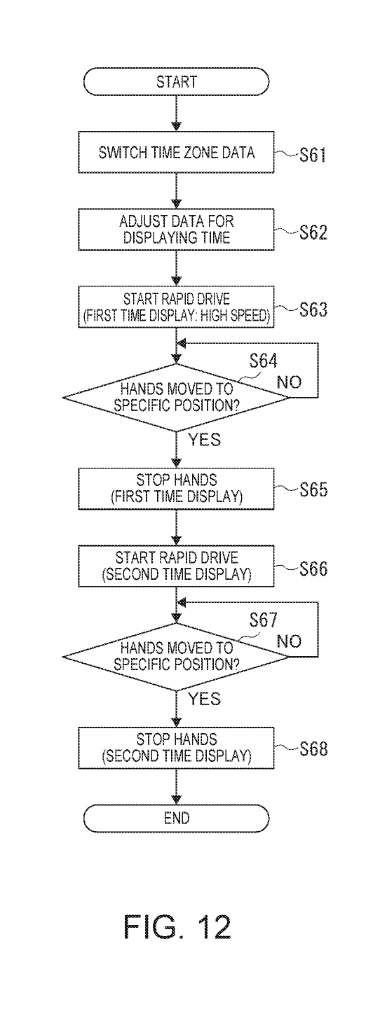

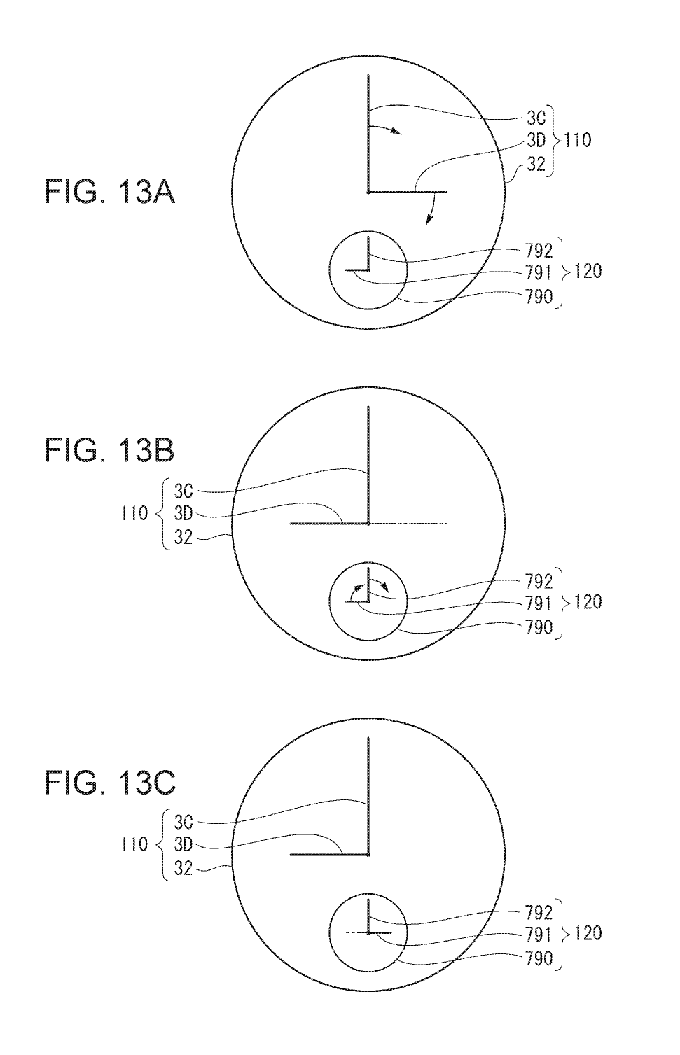

FIG. 12 is a flow chart of the time zone switching process S60, and FIGS. 13A-C illustrate driving the hands 3C, 3D, 791, 792 rapidly in the time zone switching mode.

As shown in FIG. 12, when the time zone switching process S60 executes, the display controller 470 goes to the time zone switching mode. As a result, the time zone setter 430 interchanges the time zone data (time zone information, time difference information) stored in the first time zone data 651 and second time zone data 652 (S61).

Next, based on the first time zone data 651 and second time zone data 652 in which the time zone data was switched, the time adjuster 450 adjusts the first time data 641 and second time data 642 (S62). In this example, the first time data 641 is changed from 3:00 to 9:00, and the second time data 642 is changed from 9:00 to 3:00.

Next, based on the adjusted first time data 641, the display controller 470 controls the first stepper motor 211 of the drive mechanism 210 and starts rapidly driving the hands 3C, 3D of the first time display 110 (S63). At this time the first stepper motor 211 drives the hands 3C, 3D at high speed.

The display controller 470 then determines whether or not the hands 3C, 3D have moved to the specific position (S64). In this example, as shown in FIG. 13A and FIG. 13B, the display controller 470 determines if the hands 3C, 3D moved from the position indicating 3:00 to the position indicating 9:00.

Returning to FIG. 12, if S64 returns No, the display controller 470 drives the hands 791, 792 rapidly until the hands 3C, 3D move to the specific position.

If S64 returns Yes, that is, if the hands 3C, 3D move to the position indicating 9:00 as shown in FIG. 13B, the display controller 470 controls the first stepper motor 211 to stop the hands 3C, 3D (S65).

Next, based on the adjusted second time data 642, the display controller 470 controls the second stepper motor 212 to start rapidly driving the hands 791, 792 of the second time display 120 (S66). The display controller 470 therefore outputs a continuous drive pulse train to the second stepper motor 212. The frequency of the continuous drive pulse train in the time zone switching mode is set the same as in the time zone selection mode and reception mode described above, that is, a high frequency (in this example, 100 Hz). As a result, in the time zone switching mode, the hands 791, 792 are driven rapidly at a high second speed.

More specifically, the control mode in which the controller 40 controls the second stepper motor 212 of the drive mechanism 210 in the time zone switching mode is an example of a second mode of the invention.

The display controller 470 then determines whether or not the hands 791, 792 have moved to the specific position (S67). In this example, as shown in FIG. 13B and FIG. 13C, the display controller 470 determines if the hands 791, 792 have moved to the position indicating 3:00 from the position indicating 9:00. More specifically, the display controller 470 calculates the number of steps required for the hands 791, 792 to move from the position at 9:00 before the time zone was selected, to the corrected position at 3:00. The display controller 470 determines whether or not the hands 791, 792 moved to the specific position by determining if the number of drive pulses required to move the calculated number of steps was output.

Returning to FIG. 12, when S67 returns No, the display controller 470 continues driving the hands 791, 792 rapidly until it determines the hands 791, 792 have moved to the specific position.

If S67 returns Yes, that is, if the hands 791, 792 have moved to the position indicating 3:00 as shown in FIG. 13C, the display controller 470 controls the second stepper motor 212 to stop the hands 791, 792 (S68).

Referring again to FIG. 4, when the time zone switching process S60 ends, processing ends.

As in the time zone selection mode and reception mode described above, the position of the hands 791, 792 can be adjusted in a short time in the time zone switching mode, which does not require manually setting the stop position of the hands 791, 792.

### Effect of the Invention

Operating effects of the above embodiments of the invention are described below.

In the reference position setting mode in this embodiment of the invention, the display controller 470 controls the second stepper motor 212 of the drive mechanism 210 to drive the hands 791, 792 at a low first speed. As a result, the user does not need to change the drive speed of the hands 791, 792 to a low speed to set the hands to the reference position. Operability is therefore improved for the user.

In the reference position setting mode in this embodiment of the invention, the hands 791, 792 can be driven one step at a time. As a result, the hands 791, 792 can be drive rapidly and moved to a position near the reference position at 00:00, and the hands 791, 792 can then be moved one step at a time to set the hands 791, 792 to the 00:00 position. The user can therefore easily set the hands 791, 792 to the reference position.

In the time zone selection mode, reception mode, and time zone switching mode in this embodiment, the display controller 470 controls the second stepper motor 212 of the drive mechanism 210 to drive the hands 791, 792 at a high second speed. As a result, the user does not need to change the drive speed of the hands 791, 792 to a high speed in order to adjust the position of the hands 791, 792 in a short time.

### Other Embodiments

The invention is not limited to the embodiments described above, and can be modified and improved in many ways without departing from the scope of the accompanying claims.

The foregoing embodiment describes an example in which the second stepper motor 212 that drives the hands 791, 792 is controlled in a first mode or second mode, but the first stepper motor 211 that drives the minute hand 3C and hour hand 3D, and a stepper motor not shown that drives the second hand 3B, small hand 771, small hand 781, and date indicator 55, may also be controlled in a first mode or second mode.

More specifically, when the user must operate the input device 70 and manually set the stop position of the hands when the hands 3B to 3D, small hand 771, and small hand 781 are driven at a high speed, the hands are driven in a rapid drive mode at a low first speed. When the controller 40 calculates and determines the amount these hands must be driven, that is, when there is no need for the user to set the position where the hands stop, these hands can be driven in a rapid drive mode at a high second speed.

The foregoing embodiment describes determining the crown 6 was turned continuously when rotation of the crown 6 is detected twice within a specific time, but the invention is not so limited. For example, that the crown 6 was turned continuously may be determined when rotation of the crown 6 is detected three within a specific time.

The foregoing embodiment describes driving the hands 791, 792 after driving the hands 3C, 3D in the reception mode and time zone switching mode, but the invention is not so limited. For example, the hands 791, 792 may be driven first, or the hands 3C, 3D and hands 791, 792 may be driven simultaneously.

The embodiment described above uses GPS satellites and quasi-zenith satellites as examples of positioning information satellites, but the invention is not so limited and the positioning information satellites in the invention may be Global Navigation Satellite System (GNSS) satellites in the Galileo (EU), GLONASS (Russia), or Beidou (China) navigation systems, or other types of positioning information satellites that transmit satellite signals carrying time information, such as SBAS and other geostationary satellites or quasi-zenith satellite.

The invention is also not limited to receiving radio waves for satellite signals from such positioning information satellites, and can also be used when receiving circularly polarized radio waves in the 900 MHz spectrum, or linearly polarized waves.

Yet further, electronic timepieces that do not receive radio waves, that is, electronic timepieces in which a reception mode is not executed, are also included in the scope of the invention.

An electronic timepiece according to the invention is also not limited to wristwatches, and the invention can be widely applied in mobile devices with a timekeeping mechanism, including devices with high power consumption such as cell phones and mobile GPS receivers used in back-country hiking.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

The entire disclosure of Japanese Patent Application No. 2018-085214, filed Apr. 26, 2018 is expressly incorporated by reference herein.

What is claimed is:

1. An electronic timepiece comprising:
an operator including a crown or a button;
a hand to indicate time;
a driver to drive the hand; and
a controller configured to control the driver to rapidly drive the hand at a first speed when a reference position setting mode for setting the hand to a reference position is set and a rapid drive command is asserted by the operator, and continuously rapidly drive the hand until a specific operation is executed with the operator, and
when a time zone selection mode for selecting a time zone of a time the hand is to display executes, and an operation selecting the time zone is executed by the operator, control the driver to rapidly drive the hand at a second speed that is faster than the first speed, and stop the hand at a position indicating a time based on the selected time zone.

2. An electronic timepiece comprising:
an operator including a crown or a button;
a hand to indicate time;
a driver to drive the hand; and
a controller configured to control the driver in a first mode in which, when a command for rapid driving is asserted by the operator, the driver rapidly drives the hand at a first speed and continues driving rapidly until a specific operation is executed by the operator, and
a second mode in which the driver rapidly drives the hand at a second speed that is faster than the first speed, and stops the hand when the hand moves to a specific position.

3. The electronic timepiece described in claim 2, wherein:
the controller has a reference position setter configured to execute a reference position setting mode to set the hand to the reference position, and
when the reference position setting mode executes, the controller controls the driver in the first mode.

4. The electronic timepiece described in claim 2, wherein:
the controller has a time zone selector configured to execute a time zone selection mode to select a time zone of a time the hand indicates, and
when the time zone selection mode executes, the controller controls the driver in the second mode, and stops the hand at a position indicating a time based on the selected time zone.

5. The electronic timepiece described in claim 2, further comprising:
a receiver configured to receive a signal containing time information;
the controller including a reception time adjuster to execute a reception mode of receiving the signal by the receiver and adjusting a time the hand indicates; and
when the reception mode executes, the controller controls the driver in the second mode, and stops the hand at a position indicating a time based on the received time information.

6. The electronic timepiece described in claim 2, further comprising:
a time display including a first time display with a first hand, and a second time display with a second hand;
the driver including a first driver to drive the first hand, and a second driver to drive the second hand;
the controller including a display controller configured to execute a time zone switching process that interchanges the times displayed by the first time display and the second time display; and when the time zone switching process executes, the controller controls the first driver and the second driver in the second mode.
